(19) United States
(12) Patent Application Publication
(10) Pub. No.: US 2002/0184501 A1
(43) Pub. Date: Dec. 5, 2002

(54) Method and system for establishing secure data transmission in a data communications network notably using an optical media key encrypted environment (omkee)

(75) Inventors: Zakir Basree Bin Abdul Rahman, Petaling Jaya (MY); Ahmad Hata Bin Hussein, Kajang (MY); Kamal Hilmi Bin Othman, Shah Alam (MY)

Correspondence Address: LYON & LYON LLP, 633 WEST FIFTH STREET, SUITE 4700, LOS ANGELES, CA, 90071, US

(73) Assignee: GLOBAL E-COMZ SDN BHD

(21) Appl. No.: 09/945,165

(22) Filed: Aug. 31, 2001

(30) Foreign Application Priority Data
May 29, 2001 (MY) PI 2001 2550

(51) Int. Cl. H04L 9/00

(52) U.S. Cl. 713/173

(57) ABSTRACT

A method of establishing secure data transmission in a communications network between a client (3) and a remote network entity (4), the method comprising the steps of:

(a) encoding a security token (5) with encrypted token and user identification information (12, 13),

(b) verifying at the client (3) the authenticity of the token identification information (17),

(c) upon verification, transmitting the user identification information (13) to the remote network entity,

(d) verifying at the remote network entity the authenticity of the user identification information (13), and

(e) verifying at the remote network entity the authorisation (8) of the user to access one or more applications.

The present invention relates generally to the secure transmission of data between a client and a remote network entity, such as a server, in a communications network, such as the Internet, an intranet, an extranet or wireless network.

It is becoming increasingly desirable to transmit confidential information between parties via the Internet in an encrypted fashion in order that the data remain unintelligible to illegal recipients or intermediate parties. The need for increased security is heightened by the ubiquitous nature of the Internet, and the side variety web-based application now provided by electronic commerce service providers.

In some instances, the confidential data is encrypted and decrypted by use of a symmetric encryption key. In this case, an identical encryption key is used by both the sender of the confidential data and the legitimate receiver to encrypt and decrypt a message transmitted between two parties. However, knowledge of the symmetric encryption key by both the sender and receiver of the confidential data adds to the risk of the key being acquired by an illegitimate recipient.

Another method of providing secure data transmission between two parties is to use two separate keys, known as a key pair, in which a first public key of the key pair is used for encryption of a message from a legitimate sender whilst a second private key of the key pair is used by the legitimate receiver for decryption of the message. This method is commonly known as asymmetric key cryptography. Typically, when a party wishes to send secure information, such as a credit card or personal identification number, to another entity, the person requests that the entity provide them with a digital certificate, which includes the entity's public key, and a number of preferred encryption algorithms. Information desired to be sent to the remote party is then encrypted with that public key and sent as cyphertext. The cyphertext can only be decrypted by using the private key of the receiving party, which is not made publicly available.

Whilst such a system provides improved security over symmetric encryption techniques, the increased use of computers and computer networks in many organisations, and the distributed manner in which private/public key pairs are stored in these organisations, increases the risk of an unauthorised person obtaining access to stored key pairs and consequently being able to illegally intercept confidential information.

There currently exists a need to provide a method of secure transmission of data that ameliorates or overcomes one or more problems of known methods and systems for providing secured communications.

It would also be desirable to provide a method of establishing secure data transmission in a communications network that minimises the risk of unauthorised interception of the data.

There also exists a need to provide a method of establishing secure data transmission in a communications network, and a system for realising such a method, that is convenient and simple for one or both parties involved in the transmission of the confidential information.

With this in mind, one aspect of the present invention provides a method of establishing secure data transmission in a communications network between a client and a remote network entity, the method comprising the steps of:

a) encoding an optical media security token with encrypted information; and

b) using the encrypted information to establish said secure data transmission.

In one embodiment, the encrypted information includes token and user identification information, step (b) including:

(c) verifying with the client the authenticity of the token identification information,

(d) upon verification, transmitting the user identification information to the remote network entity,

(e) verifying that the remote network entity the authenticity of the user identification information, and

(f) verifying at the remote network entity the authorisation of the user to access one or more applications.

In one embodiment of the invention, the optical media security token comprises optical media such as a CD-ROM, DVD or CD-MO.

A secure data transmission method having these steps provides a multiphase process of authentication in an optical media key encryption environment (OMKEE) to ensure the integrity and confidentiality of the communication between a user and an application.

Conveniently, step (a) may include generating a first digital certificate including the token identification information, and storing the first digital certificate on the security token. In this case, step (c) may include decrypting the first digital certificate, and comparing the token identification information with reference token identification data.

Step (a) may also include generating a second digital certificate including the user identification, and storing the second digital certificate on the security token. In this case, step (c) may include decrypting the second digital certificate by using the public key of a Certification Authority. Step (c) may then include comparing the user identification information with a certificate revocation list maintained by the Certification Authority.

Step (d) may include generating client data for transmission to the remote network entity, attaching a user digital signature to the client data, and transmitting the client data and user digital signature to the remote network entity. The decrypted second digital certificate may be used in step (c) to decrypt the client data at the remote network entity.

Step (f) may include sending a challenge value from the remote network entity to the client, sending a response value from the client to the remote network entity, and comparing the challenge and response values at the remote network entity. A user password may be maintained in a user profile database, the response value being generated at the client by using the user password, a user private key and the challenge value. The challenge and response values may then be compared at the remote network entity by using the user password, a user public key and the challenge value.

In one embodiment, step (c) may be repeated up to a predetermined number of times to verify user access authorisation.

Another aspect of the invention provides a secure data transmission system comprising a client and a remote network entity interconnected by a communications network, the client being adapted to read an optical media security token bearing encrypted information.

In one embodiment, the encrypted information includes token and user identification information, the client including a first data processing unit and associated memory device for storing code to cause the client to verify the authenticity of the token identification information, and, upon verification, transmit the user identification information to the remote network entity, and wherein the remote network entity includes a second data processing unit and associated second memory device for storing code to cause the remote network entity to verify the authenticity of the user identification information, and to verify the authorisation of the user to access one or more applications.

The code may cause the client and/or remote network entity to perform any of the above described steps.

Another aspect of the invention provides a remote network entity for use with the data transmission system as previously described, the remote network entity including a data processing unit and associated memory device for storing code to cause the remote network entity to verify the authenticity of the user identification information, and verify the authorisation of the user to access one or more applications.

Yet another aspect of the invention provides a client for use with a secure data transmission system as described previously, the client including a data processing unit and associated memory device for storing code to cause the client to verify the authenticity of the token identification information, and, upon verification, transmit the user identification information to the remote network entity.

The following description refers in more detail to the various features of the invention, to facilitate an understanding of the invention, reference is made in the description to the accompanying drawings where the method and system for establishing secure data transmission in a communications network is illustrated in a preferred embodiment. It is to be understood, however, that the invention is not limited to the preferred embodiment.

In the drawings:

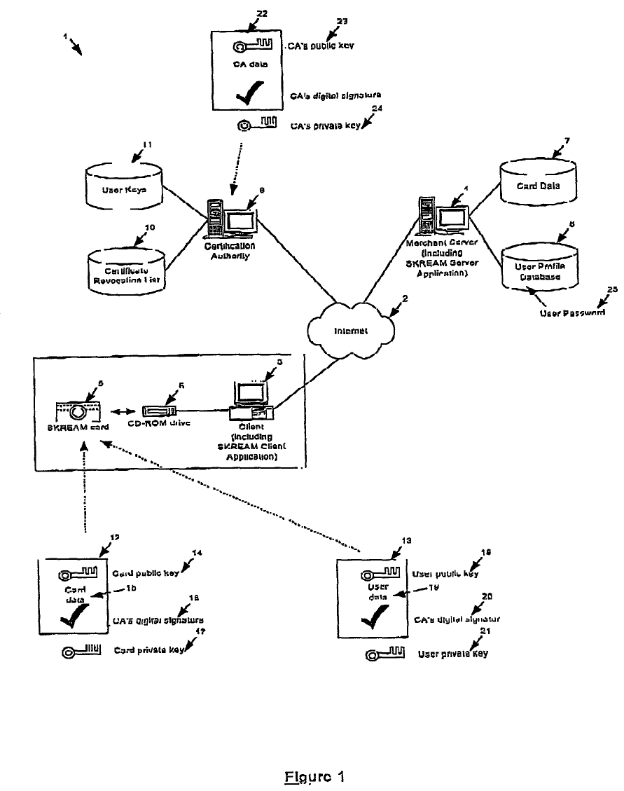

FIG. 1 is a schematic diagram illustrating a secure data transmission system for implementing the method of the present invention; and

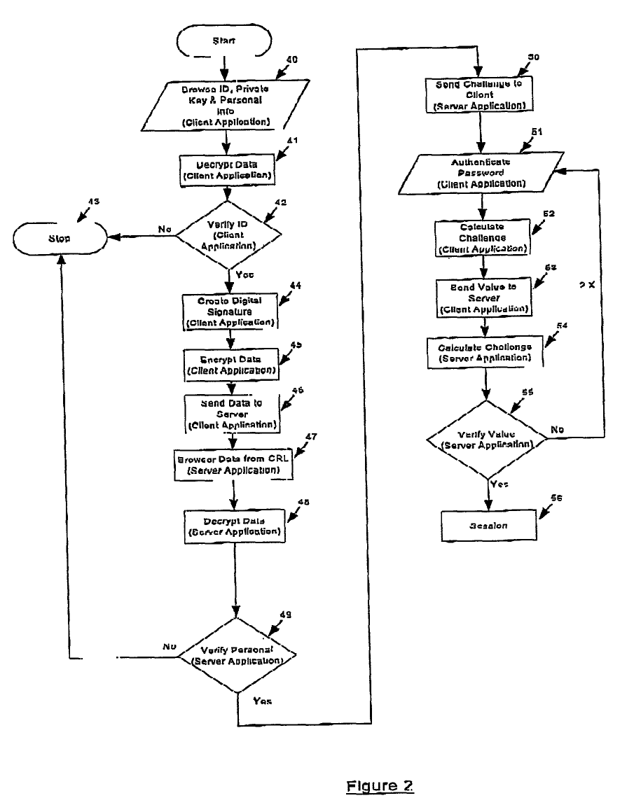

FIG. 2 is a flow diagram illustrating one embodiment of a method of establishing secure data transmission using the system of FIG. 1.

Turning now to FIG. 1, there is shown generally a system 1 for establishing secure data transmission in a communications network 2, in this case the Internet. It will be appreciated that in other embodiments of the invention, the secure data transmission may take place in other types of communications networks, for example, mobile communications or satellite networks.

The data transmission system 1 includes a client 3 and remote network entity 4, such as a merchant server, connectable to the Internet 2. A optical media security token 5, such as a CD-ROM, DVD, CD-MO or other optical storage media, is encoded with encrypted information that can be read by the client 3 by means of an optical media token reading device 6. The merchant server 4 provides access to one or more applications that require the authentication of the user's identity, and the secure transmission of the data between the client and the merchant server. A card data database 7 and user profile database 8 are accessed by the merchant server 4 in order to facilitate the establishment of secure data transmission from the client to the merchant server 4.

A Certification Authority 9 then issues and manages authentication information, such as digital certificates, is also connected to the Internet 2. A certificate revocation list database 10 is maintained by the Certification Authority 9. Moreover, a database 11 of public keys issued to users is maintained. The client 9 includes a data processing unit and associated memory device for storing code to enable the client to perform the required functionality of the secure data transmission system. Similarly, the merchant server 4 includes a data processing unit and associated memory device for storing code that enables complementary functionality to be achieved by the merchant server 4.

The security token 5 is encoded with encrypted token and user identification information, embodied in this instance by two digital certificates 12 and 13 issued by the Certification Authority 9. The digital certificate 12 includes a public key 14 and identification and other data 15 associated with the security token 5. The digital certificate 12 is encrypted with a digital signature 16 generated by the Certification Authority 9 from that Authority's private key. The private key 17 corresponding in the public key 14 is also stored on the security token 5.

The digital certificate 13 similarly includes a public key 18 and identification and other related data 19 associated with the user to whom the security token 5 is issued by the Certification Authority 9. The digital certificate 13 is encrypted by a digital signature 20 from the Certification Authority 9. A private key 21 corresponding to the user public key 18 is also stored on the security token 5.

A digital certificate and public/private key pair 23, 24 is maintained by the Certification Authority 9, the digital certificate 22 and Certification Authority's public key 23 being available to the client 3 and merchant server 4 via the Internet 2.

In use, the Certification Authority 9 stored the digital certificates 12 and 13 and private keys 17 and 21, respectively enabling identification of the security token 5 and user to whom the token has been issued, on the security token 5. The token is then issued to a user for use in establishing a secure data transmission between the client 3 and the merchant server 4.

Upon insertion of the security token 5 into the token reader 6, the client application establishes a connection to the Internet 2 and from there to the server application of the merchant server 4. Both the client application and server application conform to the Secure Sockets Layer (SLL) and Transport Secure Layer (TSL) formed between the application layer and the transport (TCP) layer of the Internet protocol used for transmission of data two and from the client 3 and merchant server 4.

All information stored in the security token 5 is encrypted. In order to be able to read the information contained in the digital certificates 12 and 13, the client application initially accesses the encrypted data at step 40, and requests the server application of the merchant server 4 to retrieve the public key 23 provided by the Certification Authority 9. Upon retrieval by the server application of the public key 23, and the transmission of this public key to the client 3, the digital certificates 12 is decrypted, at step 41, and the token identification information 15 compared in reference token identification data maintained in the card database 7 by the merchant server 4. If corresponding valid token identification data is located, at step 42, in the card data database 7, the authenticity of the security token 5 is taken to be valid. If no corresponding data is located, the client application halts the establishment of a secure connection between the client 3 and merchant server 4, at step 43.

Once the authenticity of the security token 5 has been validated, any client data generated by the client 3 that may be required to be transmitted to the merchant server 4 is encrypted by means of the user private key 21. Accordingly, a hash function is used on the client data to be transmitted to the merchant server 4, and the corresponding message digest signed with the user private key 21 to create a user digital signature at step 44. The client data is then encrypted with the digital signature at step 45 and the encrypted data sent to the merchant server 4 at step 46. In addition, the user's digital certificate 13 is transmitted to the merchant server 4.

The server application then uses the Certification Authority's public key 23 to validate the user's digital certificate 13, and then validates the digital signature encrypting the client data by means of the validated user digital certificate 13.

At step 47, the server application retrieves the certificate revocation list from the database 10 of the Certification Authority 9 to verify the user's digital certificate 13. The server application verification process check the expiry date and integrity of the digital certificate 13, as well as whether the certificate has been issued by a trusted certification authority and whether the certificate has been revoked. Typically, the digital certificate 13 is X.509 compliant. If the certificate is not valid, the client application will halt all processes and terminate the connection with the merchant server 4, otherwise the server application will then decrypt all received data from the client application at step 48. Moreover, the status of the user's digital certificate 13 as reported by the verification function performed by the server application will be recorded in the user profile database 8.

The encryption algorithm used to encrypt the data, which may typically be RSA, BLOWFISH, Triple DES and MD5 compliant, is stored on the optical media storage device.

If the user's digital certificate is not rejected by the verification function, a search is made in the user profile database 8 for the corresponding user profile using a combination of the user's full name and unique identification number, as identified by the user identification and related data 19 included in the digital certificate 13. If no corresponding record is found or viewed at step 49, the session is terminated by the server application and the user is prevented from proceeding further with the establishment of a secure data transmission.

Alternatively, if a unique record is found, the server application then checks the user access authorisation to one or more applications posted, in this example, on the merchant server 4. This is achieved using a challenge-response method for password verification. A user password 25 is included in each user profile maintained in the user profile database 8. Initially, a random challenge value is generated by the server application and forwarded to the client application at step 50. After entry by the user of the user password at the client 3, the user password is authenticated at step 51, by the client application generating a response value using the user password, the user private key 21, and the challenged value received from the server application, at step 52. At step 53, the response value is transmitted from the client 3 to the merchant server 4. When the server application receives the response value from the client application, the merchant server 4 then computes a value with the same calculation formula using the challenge value sent by the client application, and using the user password retrieved from the user profile maintained in the user profile database 8, and the user public key 18 (as provided by the Certification Authority 9 from the user keys database 11). The server application then compares the challenge value with the user's response value at step 54.

If the challenge and response values are determined by the server application to be equal at step 55 the client application is provided with access to one or more of the applications hosted at the merchant server 4, at step 56. Otherwise, the client application will once again prompt the user to enter their password at the client 3, in which case steps 51 to 55 will be repeated up to a predetermined number of times in order to verify the authorisation of the user to access the application or applications hosted by the merchant server 4. If the user's password is rejected more than that predetermined number of times, the user profile maintained in the user profile database 8 will be recorded as invalid, and the user will be required to apply to the organisation maintaining the merchant server 4 for reactivation of the user account.

Typically, the digital certificate 13 may contain the full name of a user and include a unique User Identification Number (UID). In some instances the UID may be a user's Identity Card Number (IC) and the full name included in the digital certificate 13 may be the same as that that appears on the user's identity card or passport.

Finally, it is to be understood that various modifications and/or additions may be made to the method or system for establishing secure data transmission as described hereabove without departing from the spirit or ambit of the present invention.

The claims defining the invention are as follows:

1. A method of establishing secure data transmission in a communications network between a client and a remote network entity, the method comprising the steps of:
(a) encoding an optical media security token with encrypted information, and
(b) using the encrypted information to establish said secure data transmission.

2. A method according to claim 1, wherein the encrypted information includes token and user identification information, step (b) including
(c) verifying at the client the authenticity of the token identification information,
(d) upon verification, transmitting the user identification information to the remote network entity,
(e) verifying at the remote network entity the authenticity of the user identification information, and
(f) verifying at the remote network entity the authorisation of the user to access one or more applications.

3. A method according to either one of claim 1 or 2, wherein the security token comprises optical media such as a CD-ROM, DVD or CD-MO.

4. A method according to any one of the preceding claims, wherein step (a) includes:
generating a first digital certificate including the token identification information, and
storing the first digital certificate on the security token.

5. A method according to claim 4, wherein step (c) includes:
decrypting the first digital certificate, and
comparing the token identification information with reference token identification data.

6. A method according to any one of the preceding claims, wherein step (a) includes:
generating a second digital certificate including the user identification information, and
storing the second digital certificate on the security token.

7. A method according to claim 6, wherein step (e) includes:
decrypting the second digital certificate by using the public key of a Certification Authority.

8. A method according to claim 7, wherein step (e) includes:
comparing the user identification information with a certificate revocation list maintained by the Certification Authority.

9. A method according to either of claims 7 or 8, wherein step (d) includes:
generating client data for transmission to the remote network entity,
attaching a user digital signature to the client data, and
transmitting the client data and user digital signature to the remote network entity.

10. A method according to claim 9, wherein step (e) includes:
using the decrypted second digital certificate to decrypt the client data at the remote network entity.

11. A method according to any one of the preceding claims, wherein step (f) includes:
sending a challenge value from the remote network entity to the client,
sending a response value from the client to the remote network entity,
comparing the challenge and response values at the remote network entity.

12. A method according to claim 11, and further including:
maintaining in a user profile database a user password,
wherein the response value is generated at the client by using the user password, a user private key and the challenge value.

13. A method according to claim 12 herein the challenge and response values are compared by using the user password, a user public key and the challenge value.

14 A method according to any one of the preceding claims, wherein step (c) is repeated up to a predetermined number of times to verify user authorisation.

15 A secure data transmission system comprising a client and a remote network entity interconnected by a communications network, the client being adapted to read an optical media security token bearing encrypted information.

16. A secure data transmission system according to claim 15, wherein the encrypted information includes token and user identification information, and wherein
the client includes a first data processing unit and associated first memory device for storing code to causing the client to verify the authenticity of the token identification information, and
upon verification, transmit the user identification information to the remote network entity, and wherein
the remote network entity includes a second data processing unit and associated second memory device for storing code to cause the remote network entity to verify the authenticity of the user identification information, and verify the authorisation of the user to access one or more applications.

17. A secure data transmission system according to claim 16, and wherein the code causes the client and/or the remote network entity to perform the steps of any one or more of claims 1 to 14.

18. A remote network entity for use with a secure data transmission system according to claim 16, the remote network entity including a second data processing unit and associated second memory device for storing code to cause the remote network entity to verify the authenticity of the user identification information, and verify the authorisation of the user to access one or more applications.

19. A client for use with a secure data transmission system according to claim 16, the client including a first data processing unit and associated first memory device for storing code to cause the client to verify the authenticity of the token identification information, and
upon verification, transmit the user identification information to the remote network entity.

20. A security token for use in a method according to any one claims 1 to 14, the optical media security token comprising optical media such as a CD-ROM, DVD or CD-MO.
